(19) United States
(12) Patent Application Publication
(10) Pub. No.: US 2012/0167521 A1
(43) Pub. Date: Jul. 5, 2012

(54) LOST FORMWORK STRUCTURE FOR MAKING STAIRCASES AND STAIR-LANDINGS, METHOD FOR MAKING SUCH STRUCTURES AND METHOD FOR THE RELATIVE APPLICATION

(75) Inventor: Piero Cretti, Morbio Superiore (CH)

(73) Assignee: PLASTEDIL S.A., Chiasso (CH)

(21) Appl. No.: 13/379,678

(22) PCT Filed: Jun. 22, 2009
(86) PCT No.: PCT/IB09/06022

§ 371 Date: Mar. 12, 2012

(51) Int. Cl. E04F 11/00; E04G 21/02; B28B 7/22

(52) U.S. Cl. 52/741.2; 249/14; 52/742.14

(57) ABSTRACT

The invention is directed to a prefabricated stair formwork structure (1) for making a stair flight, comprising: a first space (A) for containing a concrete cast defined by two longitudinal beam elements (11, 12), arranged parallel to one another, and two transversal beam elements (13,14), also arranged parallel to one another and each coupled with both said longitudinal beam elements (11, 12) at their respective ends; a plurality of shaped elements (15) each defining a second containment space (S) for a concrete cast of corresponding steps, said shaped elements (15) being fixed in succession above said at least two longitudinal beam elements (11, 12); an element (16) for closing the bottom of the formwork structure (1), fixed to said longitudinal and/or transversal beam elements on the opposite side with respect to said shaped elements (15); and a reinforcement structure (C) of the concrete housed in said first containment space (A). The invention is also directed to a prefabricated formwork structure for making a stair landing, comprising: two longitudinal beam elements and two transversal beam elements coupled with both of said longitudinal beam elements to define a containment space for a concrete cast; an element for closing the bottom of the formwork structure, fixed to said longitudinal and/or transversal beam elements; and a reinforcement structure for the concrete housed in said containment space.

### BACKGROUND OF THE INVENTION

The present invention refers to a lost formwork structure for making, in the building industry, staircases or stair-landings, to a method for making such a formwork and to a method for its application on a construction site.

### PRIOR ART

In the building industry, prefabricated and modular constructive elements are known to be made, which can be assembled on the construction site to form staircases so that the upper floors of the building can be reached on foot.

For the purpose of the present invention, by flight of stairs we mean to identify a building element provided with adjoining steps, or rather steps that are arranged in succession, by stair-landing we mean to identify a flat building element foreseen in an intermediate position between two consecutive flights of stairs, and by staircases we mean to identify the unit formed by at least two flights of stairs connected by an intermediate stair-landing. By prefabricated element we mean to identify a building element which is not made on the construction site, but rather at a remote production site from which it is then sent to the construction site and mounted.

Normally the prefabricated building elements are made from reinforced concrete or concrete.

As an example, Japanese patent application no. JP 2005146687 discloses a prefabricated flight of stairs made from reinforced concrete, intended to be definitively bonded together on-the construction site to other flights of stairs of the same type, to form a complete staircase. The flight of stairs is modular and comprises the upper stair-landing, i.e., such a stair-landing is integrated with the flight of stairs.

The use of the prefabricated elements allows the staircase construction time to be reduced with respect to the conventional techniques which foresee the construction of the flights of stairs and of the relative stair-landings as floors which are anchored to the walls which define the same flights and stair-landings, at the sides. However, the construction of staircases through prefabricated elements has substantial drawbacks in terms of versatility of the installations, application time, costs, safety on the construction site, etc..

A first drawback comes from the fact that the prefabricated flights of stairs, with the relative stair-landings, are heavy. For example, a flight of stairs the width of which is of between 0.90 and 1.50 meters, provided with 10 steps with a height equal to 30 cm, made from concrete, can weigh between 2 and 4 tonnes. The transportation on the construction site, for its application, therefore requires the use of big vehicles, costly machines for elevating the flights on the construction site, the use of numerous posts for supporting the prefabricated elements in the buildings, and the involvement of qualified personnel that is capable of managing all the steps of its application. The use of the vehicles and of the transport machines has a negative impact upon the simplification of the logistics and the costs.

A further drawback is connected to the safety of the workers. The transportation and the movement of the prefabricated elements, for their application on the construction site, are dangerous for the safety of the workers. In the case of an accident, the substantial weight of these elements can indeed cause a person to be crushed and killed.

Another drawback is due to the fact that the prefabricated elements of the staircase, once made according to the technical specifications of the customer, cannot be modified. In practice, each element is made in-house, arranging a custom-made formwork and casting the concrete into the formwork. Once the cast is set, the prefabricated element is extracted from the formwork and sent to the construction site for its application. If it is needed to have modified prefabricated elements, for example modified sizes, shapes or metal reinforcements, it is necessary to prepare a new formwork and make new prefabricated elements meeting the new technical specifications. This operation is time consuming and, in the case in which the weight or the dimensions of the prefabricated elements are increased, it may require new and suitable logistics, with further obvious complications. Each formwork corresponds to a single type of prefabricated element.

A further drawback of the conventional solutions is due to the fact that the prefabricated elements, installed on the construction site, are kept in the desired position through numerous posts. Preparing the posts for their application is time consuming. The posts are removed when the concrete has finished setting, for example, after around 28 days. During this period of time, the posts-occupy the flights of stairs and stop them from being able to be used, even as simple service staircases.

### SUMMARY OF THE INVENTION

The technical problem forming the basis of the present invention is therefore that of providing a structure for making staircases which overcomes the drawbacks of the conventional solutions, being easily adaptable to the construction site needs, relatively light and easy to be transported and handled.

In one first aspect, the present invention thus concerns a prefabricated and lost formwork staircase structure, according to claim 1.

In particular, in such a first aspect, the present invention refers to a prefabricated staircase formwork structure for making a flight of stairs, comprising:
a first containment space for a concrete cast, defined by two first longitudinal beam elements, arranged parallel to one another, and two first transversal beam elements, also arranged parallel to one another and each coupled with both of said first longitudinal beam elements at the respective ends,
a plurality of shaped elements each of which define a second containment space for a concrete cast of corresponding steps, said shaped elements being fixed in succession above said at least two first longitudinal beam elements, and
an element for closing the bottom of the formwork structure, fixed to said first longitudinal beam elements and/or to said first transversal beam elements on the opposite side with respect to said shaped elements, and
a reinforcement structure of the concrete housed in said first containment space.

For the purpose of the present invention by “beam element” we mean to identify any structural element having one dimension substantially greater than the other two dimensions. By “coupled at the respective ends” referring to the longitudinal and transversal beam elements, we mean that the ends of such elements, are stably connected to one another, or that an end of a beam element is fixedly connected to a portion of the other beam element, near to the relative end, for example, a portion whose distance from such an end is less than 10% of the total length of the same beam element. The coupling can be obtained through mechanical attachments such as screws, pins or couplings, or preferably through welding or rivets.

The formwork staircase structure is simple to make and relatively light, given that the concrete, which gives a flight of stairs most of its weight, is cast at the construction site. The structure is therefore also easy to transport and handle and it is simple to position during application. As shall be described in detail in the rest of the present description, possible modifications of dimensions or shape, required by the user, are easily obtained in-house during the construction of the formwork structure or also on the construction site, before application.

In a second aspect, the present invention concerns a prefabricated and lost stair-landing formwork structure, according to claim 2.

In particular, in its second aspect, the present invention refers to a prefabricated structure of a stair-landing formwork for making a stair-landing, comprising:
two first longitudinal beam elements, arranged parallel to one another, and two first transversal beam elements, also arranged parallel to one another and each coupled with both of said first longitudinal beam elements at the respective ends to define a containment space for z concrete cast, and
an element for closing the bottom of the formwork structure, fixed to said first longitudinal beam elements and/or to said first transversal beam elements, and
a reinforcement structure of the concrete housed in said containment spade.

In general, the staircase formwork structure and the stair-landing formwork structure can be used independently from one another; however, they are preferably used together and can be fixedly attached together in the application step. The staircase formwork and stair-landing formwork structures are of the “lost” type, i.e., they remain incorporated in the concrete cast.

The stair-landing formwork structure has the same advantages as the staircase formwork structure, being light, simple to make or modify, simple to transport and to apply on the construction site.

For the sake of simplicity, in the rest of the present description we shall refer to a single formwork structure, with it being understood that the characteristics described, are common to both the staircase formwork structure and the stair-landing formwork structure, except when specified differently.

The beam elements constitute the supporting elements of the formwork structure and they must offer suitable mechanical strength to bear the weight exerted by the concrete cast and the mechanical stresses to which they are subjected.

Preferably each of the first transversal beam elements is provided with a plurality of through holes. The holes have the main function of allowing reinforcement bars to be inserted into the first containment space of the concrete and/or of allowing the formwork structure to be fixed to walls or onto other structures of the building through dowels or equivalent fixing means during the application on the construction site. The holes have the further function of minimizing the weight of the relative beam elements and of allowing the possible placement of corrugated tiles for laying cables, or the placement of piping.

Preferably, the through holes of each of said at least two first beam elements, are lined up With corresponding through holes of the other transversal beam element. The reinforcement structure comprises a plurality of reinforcement bars which pass through some through holes, or all of them, and extend into the first containment space parallel to the first longitudinal beam elements.

More preferably, the aforementioned at least two first longitudinal beam elements extend parallel to the direction of development of the flight of stairs or of the stair-landing, i.e., the main development direction, and the at least two first transversal beam elements extend perpendicularly with respect to the longitudinal beam elements. For example, the main direction of development of the flight of stairs is perpendicular to the direction of the steps.

Preferably, the formwork structure comprises one or more second transversal beam elements arranged in the first containment space, parallel to the at least two first transversal beam elements. The second transversal beam elements are coupled with the at least two first longitudinal beam elements at an intermediate portion thereof. The second transversal beam elements-are provided with through holes aligned with corresponding through holes of the at least two first transversal beam elements. The reinforcement structure comprises metal bars which pass through the first and the second transversal beam elements at the relative through holes. The transversal bars project out from the side of the formwork structure when it is necessary to fix the same bars to walls of the building. Alternatively, the transversal bars do not project out sideways from the formwork structure, or they only project out from one side, according to the needs of the construction site and of the attachments to be carried out.

Preferably the formwork structure comprises one or more second longitudinal beam elements arranged in the first containment space, parallel to the at least two first longitudinal beam elements. The second longitudinal beam elements are coupled with the transversal beam elements at an intermediate portion thereof.

Preferably, the longitudinal beam elements are provided with aligned through holes: the holes of a longitudinal beam element are aligned with corresponding holes of the remaining parallel longitudinal beam elements. The reinforcement structure comprises a plurality of reinforcement bars, for example, metal bars, which pass through the through holes and extend into the containment space, parallel to the transversal beam elements.

Preferably, the longitudinal and transversal beam elements are substantially C-shaped slab elements. For example, such beam elements can be made starting from a metal strip suitably bent along two bending lines, which are parallel to the same longitudinal direction of development of the strip.

Preferably the shaped elements foreseen in the formwork stair structure are each provided with a riser portion of the corresponding step and with two side portions adjacent to said riser portion. The upper edge of the riser portion and the upper edge of the two side portions define a support surface for covering elements of the corresponding step, for example, a granite slab.

In one embodiment, the riser portion of the shaped elements and/or the side portions have a plurality of through holes. Metal reinforcement bars can be inserted through such holes.

In one embodiment of the ,formwork staircase, the transversal reinforcement bars are arranged through the through holes of the side portions of the shaped elements, parallel to the riser portion. In this configuration the concrete cast in the containment space defined by each shaped element is of the same type as the concrete cast in the containment space between the beam elements.

In another embodiment, in which reinforcement bars are not inserted into the shaped elements, the concrete cast in the containment spaces defined by each shaped element is lightened with inert fillers.

The closing element can be made as a single panel, or it can in turn comprise many panels. Preferably, the panels are made from magnesite.

According to a preferred aspect of the present invention, the first transversal beam elements and/or the first longitudinal beam elements are provided with seats for engaging with elements for fixing onto external building structures, for example, pre-existing floors or walls, or onto other formwork structures, or they are provided with suitable fixing elements, such as, for example, expansion dowels, screws, etc..

In one embodiment of the formwork stair-landing structure, two or more stringers are fixed beneath the longitudinal beam elements and/or to the transversal beam elements to horizontally support the formwork structure at a predetermined height with respect to the ground. This configuration facilitates the application of the formwork staircase. Once the formwork has been fixed to other structures, the stringers can be removed if necessary, for example, they can be cut or dismantled.

The formwork structure according to the present invention is self-supporting. Once fixed onto a structure of the building, it is possible to proceed to the concrete casting. The posts or other supporting elements, if used, can be removed straight after. The staircase thus formed can therefore be used immediately, as a service-staircase, by the personnel of the construction site. In other words, it is not necessary to wait for the concrete to be fully set, in order to access the staircase; it is sufficient for the concrete to have hardened enough to allow it to give support to the structure. A further advantage is given by the fact that the formwork structure can be coupled with a temporary handrail, which instantly ensures the safety of the staircase.

In a third aspect, the present invention concerns a method according to claim 17 for making a formwork structure as described above.

In particular, the method comprises the steps of:
a) providing a strip of metal plate,
b) providing at least four beam elements, each having a predetermined length, bending the strip at at least two longitudinal bending lines with respect to the development of the strip itself and cutting the strip,
c) coupling said four beam elements, parallel two by two,
d) forming a containment space for a concrete cast between said at least four beam elements coupled by fixing one or more closing elements beneath two or more of said beam elements,
e) arranging a concrete reinforcement structure in said containment space.

The construction of the formwork is carried out in-house, according to the specific requirements of the customer. The structure thus prefabricated is sent to the construction site for its application. Possible modifications of the shape or dimensions can be carried out both in-house and on the construction site, by cutting and welding or riveting the beam elements.

Preferably the reinforcement structure comprises a plurality of reinforcement bars. The reinforcement bars are positioned in the containment space and through some or all of the aligned through holes located in the parallel beam elements.

More preferably on each beam element, there are through holes, which are aligned with the holes of the parallel beam element, and the step e) of the method in turn comprises the step of arranging some reinforcement bars, parallel to two (longitudinal) beam elements and other reinforcement bars parallel to the remaining two (transversal) beam elements. In this configuration the reinforcement bars cross each other in the containment space of the concrete cast.

According to needs, the metal bars can project from one or more sides of the formwork structure, or from all the sides, through the through holes of the beam elements, or they can only extend in the concrete containment space, without projecting outwards from it. The bars that project from the formwork structure are fixedly connected to structures of the building.

Preferably, the strip of metal plate is initially wound in a reel. The step a) of the method in turn comprises the step of unreeling and straightening the strip.

Preferably the strip is made from galvanized metal plate, resistant to corrosion.

In one embodiment, during step b) the strip is bent by about 90° along the aforementioned bending lines; the section of the resulting beam element is substantially C-shaped.

Preferably the method described above comprises the further step of providing further beam elements and coupling them with the already mentioned four beam elements, parallel to two of them. In other words, the first four beam elements are coupled to form a frame, and the further beam elements are coupled with the first four beam elements so as to form an inner cradle of the frame.

If the method is for building a formwork staircase structure, the following further step is foreseen:
g) fixing a plurality of shaped elements onto at least two beam elements at an upper portion thereof, each of said beam elements defining a space for the concrete cast of corresponding steps, arranged parallel to the remaining two beam elements. The shaped elements allow just as many containment spaces for corresponding concrete casts to be created.

In a fourth aspect, the present invention concerns a method according to claim 25 for the construction of a flight of stairs in a building.

In particular, the method comprises the steps of:
h) providing a formwork structure according to any one of claims 1 and 3-16,
i) fixedly connecting one of said two first transversal beam elements to a structure of the building foreseen at a first height and fixedly connecting the other first transversal beam element to a structure of the building foreseen at a second height which is greater compared to the first height,
l) fixing said closing element beneath said first longitudinal beam elements and/or to said first transversal beam elements, on the opposite side with respect to said shaped elements,
m) arranging a reinforcement structure for a concrete cast in said containment space, and
n) filling with the concrete cast the first containment space, defined by said first transversal and longitudinal beam elements and by said closing element.

As already mentioned, the closing element can be, for example, a slab of magnesite or of wood, fixed to the beam elements to close the bottom of the structure.

Preferably the reinforcement structure comprises a plurality of reinforcement bars and step m) further comprises the arrangement of the reinforcement bars in the containment space, with each bar extending through corresponding aligned holes of the first longitudinal beam elements, parallel to the first transversal beam elements.

In one embodiment of the present invention, a plurality of reinforcement bars, is inserted through corresponding through holes formed in the side portions of the shaped elements, parallel to the respective riser portions.

Preferably, the method comprises the step of closing the vacant holes of said first transversal beam elements with closing elements, before the concrete cast. For example, the vacant holes can be obstructed with slabs of magnesite to avoid that the liquid concrete, cast in the formwork structure, comes out.

Preferably, the method comprises the step of filling the second containment space, defined by each of the shaped elements, with a concrete cast and the step of closing, at the top, said shaped elements with slabs of a coating material, so as to form the steps of the flight of stairs.

The structure of the building can be a wall or a stair-landing; consequently, the reinforcement bars project from the wall or from the stair-landing or they are anchored to the wall or to the stair-landing.

In a fifth aspect, the present invention concerns a method according to claim 30 for the construction of a stair-landing in a building.

In particular, the method comprises the steps of:
o) providing a formwork structure according to any one of claims 2-16,
p) horizontally fixedly connecting said formwork structure to a structure of the building at one or more first beam elements,
q) fixing said closing element beneath said first longitudinal beam elements and/or to said first transversal beam elements,
r) arranging a reinforcement structure in said containment space, and
s) filling the first containment space defined by said first transversal and longitudinal beam elements and by said closing element with a concrete cast.

Preferably the reinforcement structure comprises a plurality of reinforcement bars and the step r) comprises the further step of arranging the reinforcement bars in the containment space, parallel to the longitudinal beam elements and through the aligned through holes of the transversal beam elements.

Preferably, and in the circumstance in which the longitudinal beam elements are also provided with aligned holes, the step r) also comprises the arrangement of a plurality of reinforcement bars in the containment space, with each bar extending through the corresponding aligned holes of the first longitudinal beam elements, parallel to the first transversal beam elements.

Preferably the vacant through holes of the first beam elements are closed with closing elements before the concrete cast. The closing elements can be, for example, slabs of magnesite or of expanded polystyrene or of plywood, etc..

At the end of the setting time of the concrete, the formwork structure and the closing elements are not removed, but remain an integral part of the flight of stairs or of the stair-landing.

The formwork structures described, prefabricated and lost, are particularly versatile. Possible modifications in dimensions with respect to the initial requirements of the customer can be carried out in the construction step or even on the construction site, by cutting and welding/riveting the beam elements.

The relative lightness of the formwork structures according to the present invention, with respect to the prefabricated structures in reinforced concrete of the prior art, makes the transportation and the application simple. The formwork structures described can be easily fixed to pre-existing structures of the building; this characteristic allows the construction time of the staircases and of the stair-landings to be heavily reduced compared to the conventional solutions.

A further advantage is given by the fact that the formwork structures fixed, to other pre-existing structures of the building, can immediately be walked upon, with due caution, even before the concrete has been cast and set.

The formwork structures described can also be associated with temporary parapets or railing, needed in order to ensure safety on the construction site. The temporary parapets or the railings are temporarily fixedly connected to the beam elements of the formwork structures, through mechanical attachments. In this way the risks of workers falling during the construction of staircases or of stair-landings are minimized. The parapets or the railings can be dismantled when they are no longer necessary.

### LIST OF FIGURES

Further characteristics and advantages of the invention shall become clearer from the following description of some of its embodiments, given as an indication and not for limiting purposes with reference to the attached drawings, in which:

FIG. 1 is a perspective top view of a first detail of a formwork staircase structure according to the present invention;

FIG. 2 is a perspective top view of a second detail of a formwork staircase structure according to the present invention;

FIG. 3 is a perspective side view, of a partially assembled formwork staircase structure, according to the present invention;

FIG. 4 is a perspective view of a partially assembled formwork staircase structure, according to the present invention;

FIG. 5 is a side and top view of a formwork staircase structure, according to the present invention;

FIG. 6 is a perspective and top view of a formwork stair-landing structure, according to the present invention;

FIG. 7 is a partial section view of a detail of a formwork structure, according to the present invention;

FIG. 8 is a schematic side view of a formwork stair structure according to the present invention in a step of its application;

FIG. 9 is a perspective view of a plurality of formwork structures, according to the present invention, during the relative application;

FIG. 10 is a perspective view of a plurality of formwork structures, according to the present invention, during the relative application;

FIG. 11 is a perspective view of a plurality of formwork structures, according to the present invention, ready to be delivered;

FIGS. 12-15 are schematic views of details of the formwork structures, according to the present invention, in a step of the relative manufacture.

### DETAILED DESCRIPTION OF THE INVENTION

With reference to the aforementioned figures, according to the present invention, a prefabricated formwork staircase structure is wholly indicated with 1 and a prefabricated formwork stair-landing structure, is wholly indicated with 1′.

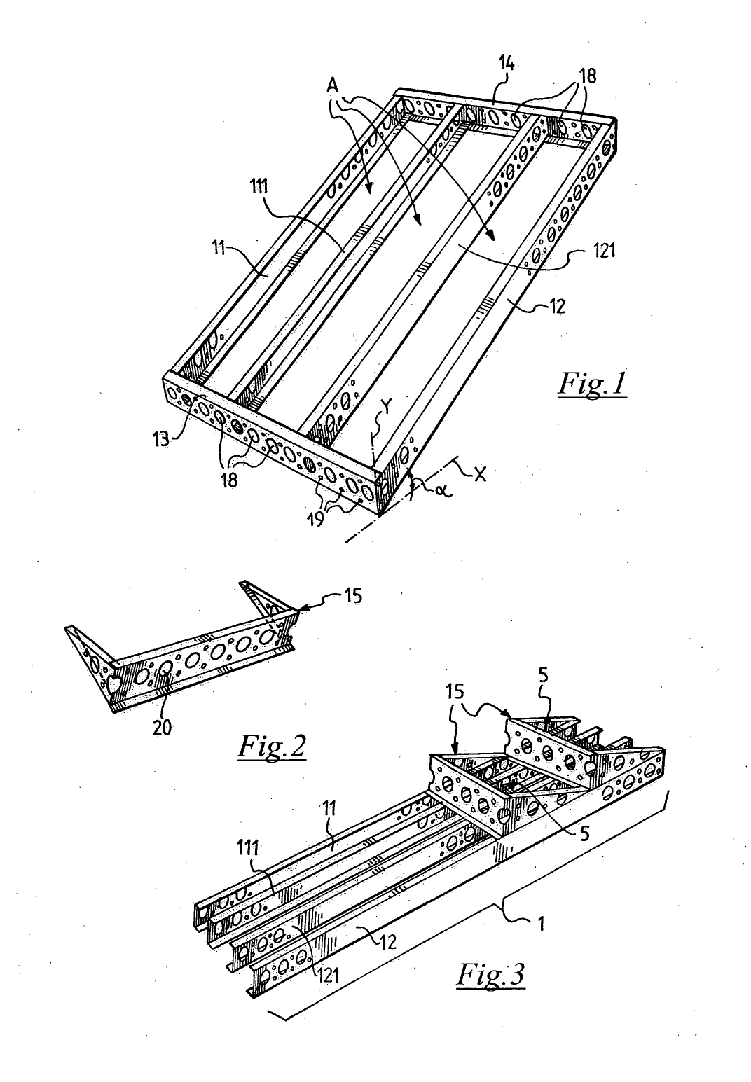

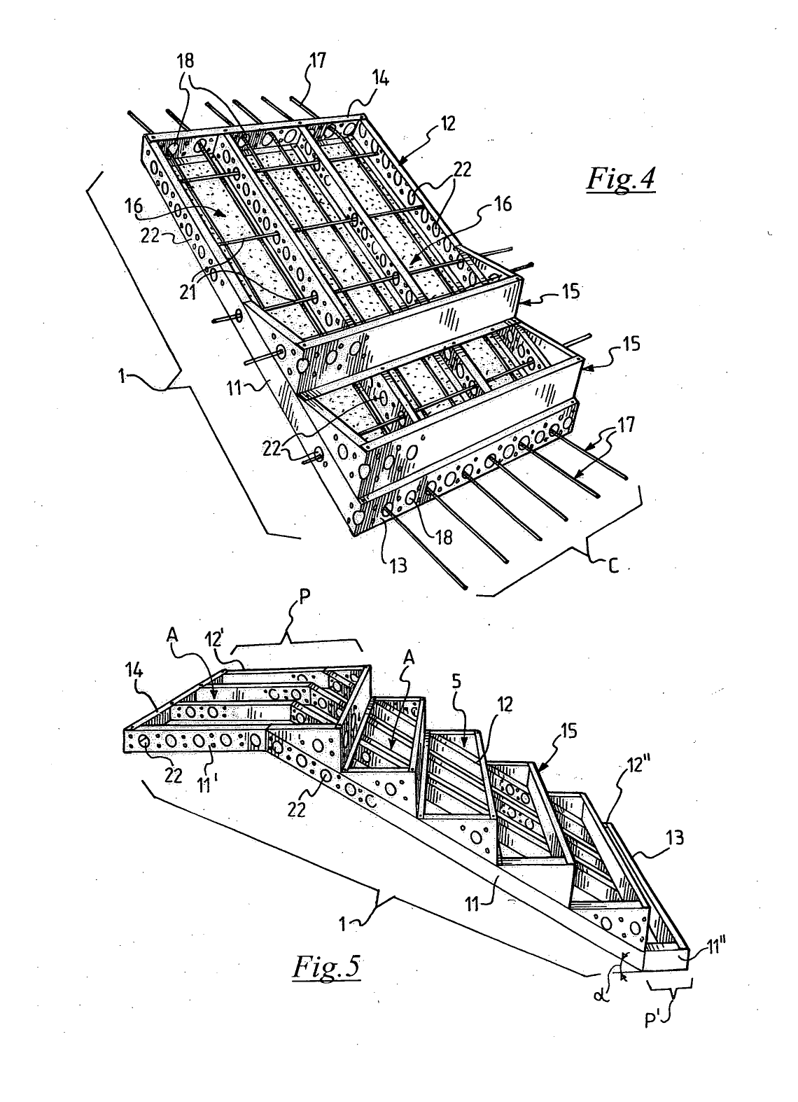

FIG. 1 shows a first detail of a formwork staircase structure 1 which is not completely assembled. The formwork staircase 1 comprises a first space A for containing the concrete cast defined by two first longitudinal beam elements 11, 12, arranged parallel to one another, and two first transversal beam elements 13, 14, also arranged parallel to one another. Each of the first transversal beam elements 13, 14 is coupled with both first longitudinal beam elements 11, 12 at the respective ends. The space A shown in FIG. 1 is open towards the bottom; indeed, the structure shown is not completely assembled, i.e., it is not ready to be used, and it does not have elements for closing the bottom of the space A. A prefabricated formwork structure 1 is shown in FIG. 4, ready to be applied.

The ends of the elements 11, 12, 13, 14 are stably attached one another with mechanical attachments and preferably with welding or riveting. In general one end of a beam element 11, 12 is fixedly attached to a portion of a beam element 13, 14 near to the relative end, for example, a portion of a beam element 13, 14 whose distance from the end is less than 10% of the total length of the same beam element 13, 14. In practice the beam elements 11, 12, 13, 14 form a frame-shaped supporting structure.

The front surfaces of the transversal beam elements 13, 14 extend vertically in the direction Y forming an angle a with a horizontal direction X, or with the ground. The angle α is selected based upon the design specifications and in practice, corresponds to the inclination the finished flight of stairs must have.

The transversal beam elements 13 and 14, but preferably also the longitudinal beam elements 11 and 12, are provided with aligned through holes 18. Such holes are clearly visible, for example, in FIG. 1. Each hole 18 of the beam element 13 corresponds to a hole 18 of the beam element 14; the two aligned holes are aligned along a longitudinal direction parallel to the longitudinal beam elements 11, 12. The holes 18 shown in the attached figures substantially have the same diameter. In general, however, the diameter of the holes 18 can vary within a predetermined range of lengths.

The holes 18 have the main function of at least partially receiving the elements of a reinforcement structure. Moreover, the holes 18 are needed to minimize the weight of the formwork structure 1 and to allow piping or electric cables to be laid in the containment space A. In FIG. 1, the reference numeral 19, indicates the holes which have a smaller diameter than that of the holes 18.

The beam elements 111 and 121 shown in FIG. 1 are parallel to the elements 11 and 12 and are each fixed to both the transversal beam elements 13, 14 at an intermediate portion. In general, the beam elements 111 and 121 are defined as second transversal beam elements and they are optional. The presence of the second transversal beam elements 111 and 121 can be necessary in order to maximize the resistance of the formwork structure to static loads. As an example, the distance between the beam elements 11, 111, 121, 12 in the example shown in FIG. 1, is equal to about 30 cm. In general, such a distance, is of between 15 and 40 cm. The first containment space A is divided into three portions by the second beam elements 111 and 121.

The beam elements 11, 12, 13, 14, 111, 121 are preferably metal sheet elements with a C-shaped profile. Alternatively, the profile of such elements can be T-shaped, double T-shaped, etc . . .

Purely as an example, the beam elements 11, 12, 13, 14, 111, 121 can be made from galvanized metal plate, the minimum thickness of which is of between 5 and 10 mm and the maximum thickness of which, is of between 10 and 15 mm.

The formwork staircase structure 1 according to the present invention also comprises a plurality of shaped elements 15 each of which define a second containment space S for a concrete cast of corresponding steps. A single shaped element 15 is shown in FIG. 2. Preferably, the shaped elements 15 are obtained starting from a strip of suitably cut and bent metal plate. In the embodiment shown in the attached figures, the shaped elements 15 are perforated so as to facilitate the possible laying of piping and/or cables or to allow transversal reinforcement bars to be inserted. For example, in FIG. 2 the through holes 20 are visible. Such holes 20 are intended to be closed with panels of magnesite, wood, polystyrene, etc., before the concrete is cast in the space S. Alternatively, the shaped elements 15 can also not have through holes.

FIG. 3 shows a portion of a formwork stair structure 1, not completely assembled, in which the two shaped elements 15 are fixed at the top to the longitudinal beam elements 11 and 12 (and if available, also to the elements 111 and 121), in succession as normally foreseen for steps. The fixing is preferably obtained through rivets, but alternatively, other mechanical attachments can, be used, for example, bolts or welding. In the example shown in FIG. 3, the shaped elements 15 are riveted to the beam elements 11, 12, 111, 121 at the upper horizontal surface of the relative C-shaped profile (this detail is very clear in FIG. 7).

The second space S defined by each shaped element 15 allows a concrete step to be made. The risers and the treads of the steps have definite sizes in the design phase, according to the required specifications of the customer. As an example, a common flight of stairs which ends in a stair-landing comprises between 8 and 12 steps and each step has risers of between 14 and 20 cm and a tread of between 25 and 40 cm.

FIG. 4 shows a formwork stair structure 1 according to the present invention, completely assembled and ready for application. For the sake of simplicity, only two shaped elements 15 are shown, fixed to the beam elements 11, 111, 121, 12; in reality, there is a greater number of shaped elements 15. In addition to the beam elements 11-14 and to the shaped elements 15, the structure 1 comprises an element 16 for closing the bottom of the structure itself. The closing element 16, is fixed to the first longitudinal beam elements 11, 12 and/or to the first transversal beam elements 13, 14, on the opposite side with respect to the shaped elements 15. In practice, the closing element 16 constitutes-the bottom of the first containment space A and stops the concrete cast from falling vertically. Preferably, the closing element 16 comprises one or more slabs made from metal material, or from wood or from magnesite. The slabs are fixed to the lower surface of the beam elements 11-14 through mechanical attachments, preferably self-tapping screws or bolts.

The fixing of the closing element 16 to the beam elements 11-14 can be carried out in-house or directly on the construction site. The latter is the preferred solution, since the workers can put down the closing element 16 at the last moment, before carrying out the concrete cast. Until that moment, the bottom of the formwork structure 1 is able to be accessed for fixing to external structures, for reinforcement and for laying pipes and/or cables, in the first containment space. Moreover, on the construction site the slabs which form the closing element 16 can be cut so as to be adapted to the needs of the moment, before fixing to the elements 11-14.

As shown in FIG. 4, the formwork structure 1 comprises, in addition to the beam elements 11-14, and to the beam elements 111 and 121, if used, to the shaped elements 15 and to the element 16 for closing the bottom, a reinforcement structure C of the concrete housed in the first containment space A. Preferably, the reinforcement structure C comprises a plurality of metal bars 17 which extend parallel to the longitudinal beam elements 11, 12.

The bars 17 each extend through the aligned holes 18 of the transversal beam elements 13, 14 and in the containment space A. The portion of metal bars 17 inside the containment space A is intended to be kept immersed in concrete. The portion of metal bars 17 which projects out from the transversal beam elements 13, 14 is intended to be anchored to pre-existing structures of the building, for example, to corresponding reinforcement of walls or stair-landings, or immersed in external casts of masonry work.

Preferably, the reinforcement structure C comprises, in addition to the bars 17 arranged longitudinally, also a plurality of bars 21, arranged transversally in the containment space A. The transversal bars 21, shown in FIG. 4, extend completely in the containment space A, for its entire width. The beam elements 111 and 121, if used, are perforated to allow the bars 21 to be passed through them.

Alternatively, the beam elements 11 and 12, and if used, also the beam elements 111 and 121, are provided with aligned through holes 22 and the bars 21 extend through said holes 22 and outside the containment space A for anchoring to external structures, like for example, the walls of a stairwell.

FIG. 5 shows one alternative embodiment of the formwork structure 1 according to the, present invention, in which the longitudinal beam elements 11 and 12 each comprise a corresponding upper extension 11′, 12′ and a corresponding lower extension 11″, 12″. The extensions 11′, 12′ and 11″, 12″ extend horizontally, or rather parallel to a floor of the building, to form an upper stair-landing P or an extension P′ for anchoring to a floor. In practice the stair-landing P and the extension P′ are integrated in the structure 1.

In alternative embodiments, the formwork staircase structure 1 can also comprise further transversal beam elements in addition to the elements 13 and 14.

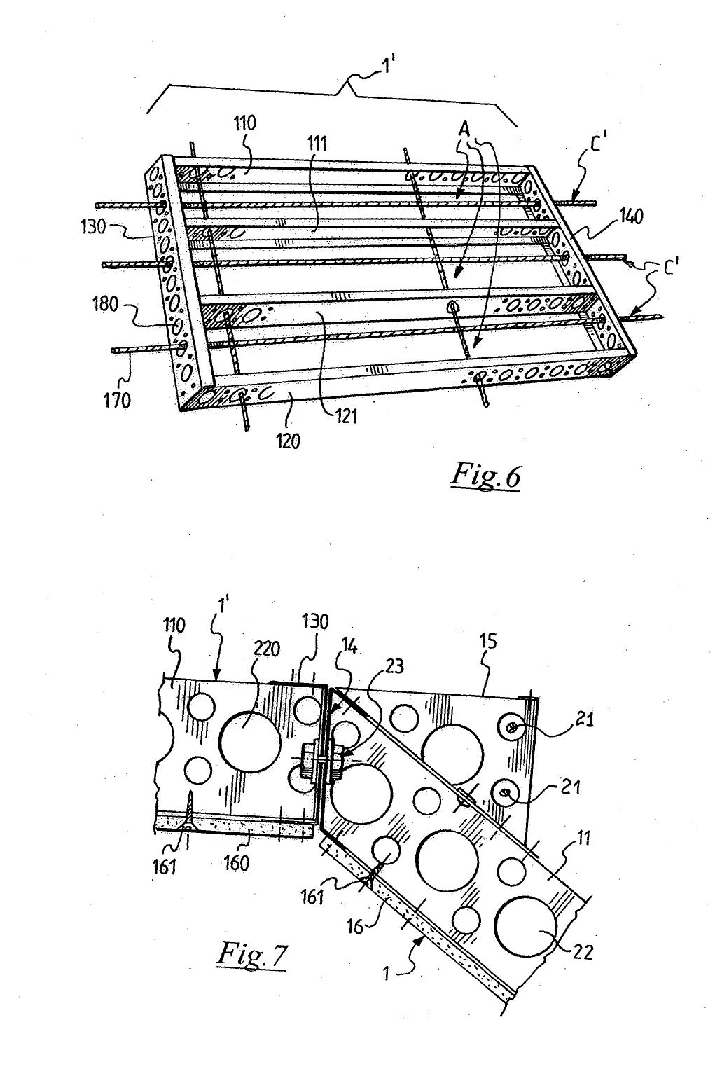

FIG. 6 shows a prefabricated and lost formwork stair-landing structure 1′, according to the present invention, intended for making stair-landings for connecting two consecutive flights of stairs. The stair-landing formwork structure 1′ is shown partially assembled for the sake of greater clarity and comprises two first longitudinal beam elements 110, 120, arranged parallel to one another, and two first transversal beam elements 130, 140, also arranged parallel to one another and each coupled with both the first longitudinal beam elements 110, 120 at the respective ends. Between the beam elements 110, 120, 130, 140, a space A′ is defined, for containing a concrete cast.

The first transversal beam elements 130, 140, and preferably also the first longitudinal beam elements 110, 120, are provided with aligned through holes 20.

The formwork structure 1′ shown in FIG. 6 also comprises the optional longitudinal beam elements 111, 121. The distance between the beam elements 110, 111, 121 and 120 is generally of between 15 and 40 cm. If used, the beam elements 111, 121, are also perforated.

The formwork structure 1′ can also be provided with further transversal beam reinforcement elements (not shown), each coupled with first longitudinal beam elements 110, 111, 121 and 120 at respective intermediate portions.

The formwork structure 1′ also comprises a bottom closing element 160. The closing element 160 constitutes the bottom wall of the containment space A′ and it is fixed to the first longitudinal beam elements 111, 121 and/or to the first transversal beam elements 130, 140 and/or to the optional reinforcement beam elements. The closing element in turn comprises one or more panels made from a suitable material, for example wood, polystyrene, and preferably magnesite, fixed to the corresponding beam elements through screws.

The formwork structure 1′ comprises a concrete reinforcement structure C′ housed in the containment space A′. This structure C′ is analogous to the structure C previously described in relation to the formwork staircase structure 1 and comprises a plurality of metal bars 170. The bars 170 extend in the space A′ and pass through the through holes 180. If needed, there can also be bars, arranged transversally in the space A′ (not shown), also projecting through corresponding holes of the beam elements 110 and 120.

It should be clear to a man skilled in the art that the formwork stair-landing structure 1′ can be used separately and independently from the formwork staircase structure 1 to make stair-landings in buildings under construction or under renovation.

FIG. 7, is a partial longitudinal section view of a formwork staircase structure 1, coupled with a formwork stair-landing structure 1′. In the example shown the coupling is obtained through bolts 23 (only one of the plurality of bolts used is visible) for locking the transversal beam element 130 of the structure 1′ to the transversal beam element 14 of the structure 1. As an alternative to the bolts, it is possible to fix the two structures 1 and 1′ to one another through couplings, welds, pins, rivets, etc . . . The threaded pins of the bolts 23 can be made in a single piece with the beam elements of the formwork structure, i.e., they can be welded to them, or they can be inserted in suitable seats (for example, holes) foreseen in the beam elements.

In general, the formwork structures 1 and 1′ can be equipped with elements for fixing onto external structures, such as screws, pins, dowels, etc., or they can be equipped with suitable housing seats for these fixing elements.

In FIG. 7, the elements 16 and 160 for closing the bottom of the structures 1 and 1′ respectively, are visible. In the examples shown, the closing elements 16 and 160 comprise one or more slabs of magnesite screwed with self-tapping screws 161.

The coupling together of the formwork structures 1 and 1′ is obtained easily during the application on the construction site. The workers can fix the formwork stair-landing structure 1′ to one or more walls of the building and, at a later time, they can bolt the formwork staircase structure 1 to the formwork stair-landing structure 1′.

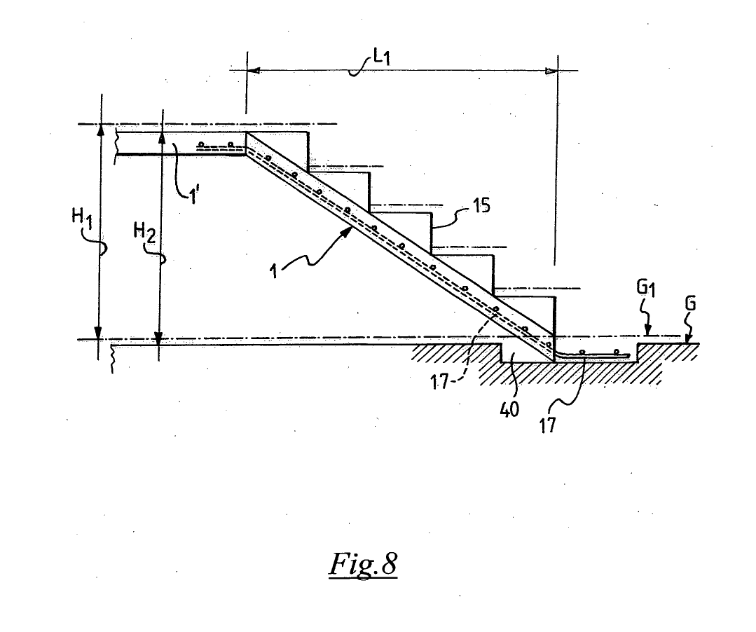

FIG. 8 schematically shows some of the design parameters, typically requested by the customer, for the construction of formwork staircase structures 1, according to the present invention. The letter G indicates a bare floor, i.e. not covered and left “unfinished”, of the building in which staircases are built through the structures 1 and 1′ described above. The letter G1 indicates the height of the coating (for example, tiles) applied to the footing G. The dimensions of the flight of stairs typically provided by the customer are the length L1 in plan of the flight of stairs, the “bare” height H1 (floor G and structure 1 and 1′ without coating), the “finished” height H2 (floor G and structure 1 and 1′ including coating), the bare width and the finished width.

The sizing of the elements of the formwork structures 1 and 1′ (number and dimensions of the beam elements, number and dimensions of the shaped elements, angle α, etc.) is carried out at the design stage, according to the dimensions provided by the customer.

The application of the formwork staircase structure 1 and of the formwork stair-landing structure 1′ shall now be described with reference to FIGS. 8-10.

As shown in particular in FIG. 8, the application is started on the lower floor and a recess 40 is made in the footing G inside of which recess, the lower part of the structure of a formwork staircase 1 is housed, and in particular the beam element 13 is housed. In this step the formwork structure 1 is kept in-position through posts or it is temporarily fixed to pre-existing structures of the building or to a formwork stair-landing structure 1′ through bolts, screws, etc., as shown in FIG. 7. The structure 1′ has in turn been fixed in position beforehand.

The reinforcement bars 17 projecting from the beam element 13 are manually anchored by the workers to the bars located in the footing G, for example, through metal wire. Thereafter, the recess 40 is filled with a filling material, restoring the footing G and incorporating the bars 17.

If there are also reinforcement bars arranged transversally in the containment space A, these bars are anchored to the vertical structures of the building, for example to the walls which define the stairwell.

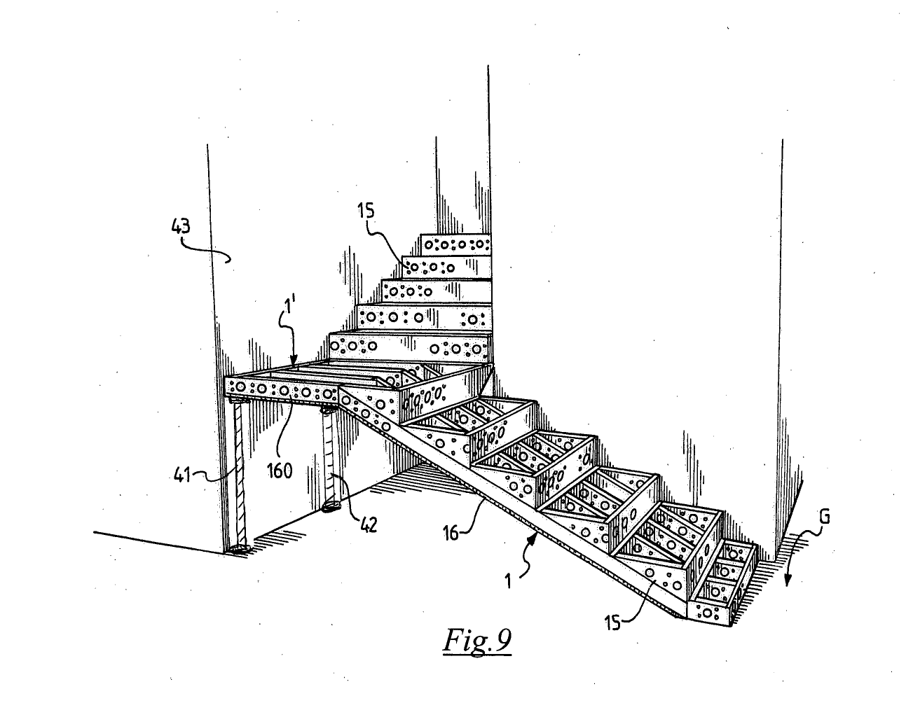

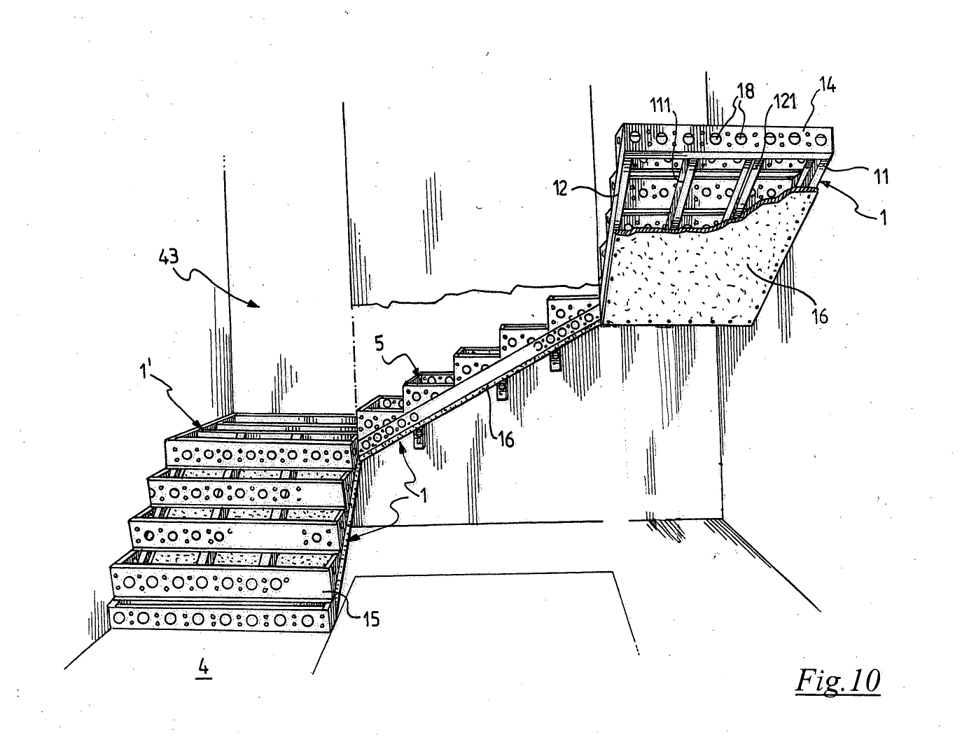

In this step the structure 1 and the structure 1′ are fixedly coupled and already able to be walked upon by the workers, with due caution. The bottom of the two structures 1 and 1′ is closed with the closing elements 16, 160, as described above. This configuration is shown in FIGS. 9 and 10: the structures 1 and 1′ are ready for a concrete cast.

FIG. 9 shows in particular a variation of the formwork stair-landing structure 1′ provided with vertical stringers 41, 42 fixed to the beam elements to support the same structure 1′ at the height set at the design stage, in addition or as an alternative to the fixing to the wall 43. As an alternative to the vertical stringers 41, 42 the structure 1′ can be associated with conventional support posts. The posts or the vertical stringers 41, 42 are removed when the concrete has become stable.

In particular, FIG. 10 shows a staircase under construction. Three formwork staircase structures 1 and two formwork stair-landing structures 1′ are used, suitably coupled as described.

The concrete cast is carried out with known techniques to initially fill just the space A of the formwork staircase structures 1 and the space A′ of the formwork stair-landing structures 1′, until the beam elements are completely covered; the spaces S defined by the shaped elements 15 are filled at a later time, at the end of the setting time of the first concrete cast. Preferably, the concrete cast into the spaces S to create the steps, is lightened with cement and polystyrene fillers, the density of which is equal to around 600-700 kg/m³.

When the steps have also been created and the concrete has finished its setting time, the exposed surfaces of the staircase can be covered with coating material, for example, bricks, slabs of marble, granite, etc . . .

The stair-landings follow the method of application of the flights of stairs.

The structures 1 and 1′ remain incorporated in the staircases made, and in this way, they are “lost” formwork structures.

At the sides of the staircase it is still possible to anchor a temporary handrail to allow instantaneous safety to be achieved and to reduce the risks of injuries.

FIG. 11 shows two formwork staircase structures 1 and a formwork stair-landing structure 1′ brought together to minimize the bulk and ready to be delivered from the factory to the construction site. To simplify transportation and logistics, the formwork staircase structures 1 and the formwork stair-landing structure 1′ do not have reinforcement structures C and C′ or bottom closing elements 16, 160. These elements can be easily provided and assembled on the construction site. The relative lightness of these structures substantially simplifies the logistics and the application.

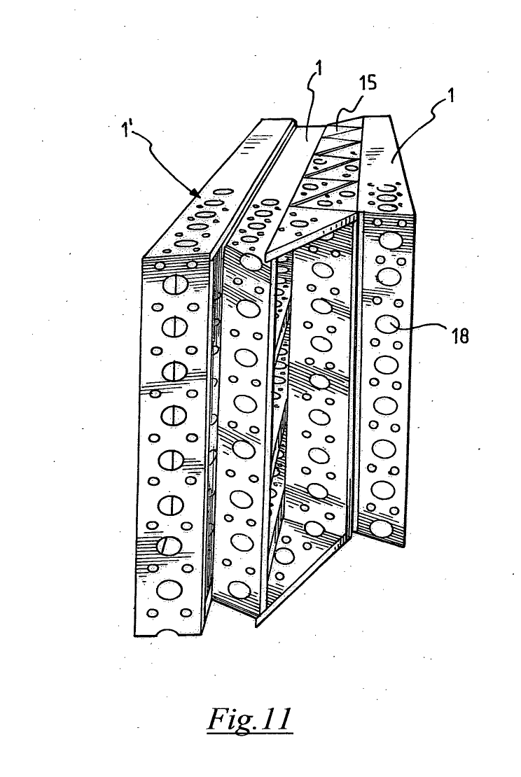

FIGS. 12-15 refer to a method for making the formwork staircase structure 1 or the formwork stair-landing structure 1′. The beam elements 11-14, 111, 121, 130-140, etc., are made starting from a strip of metal plate 31 which has undergone bending at two parallel lines 32 and 33 longitudinal with respect to the length of the strip, shown in FIG. 13, and cut transversally at a predetermined length. Preferably, the metal strip 31 is made from galvanized metal plate. More preferably, the metal strip 31 is perforated with through holes 18, 19.

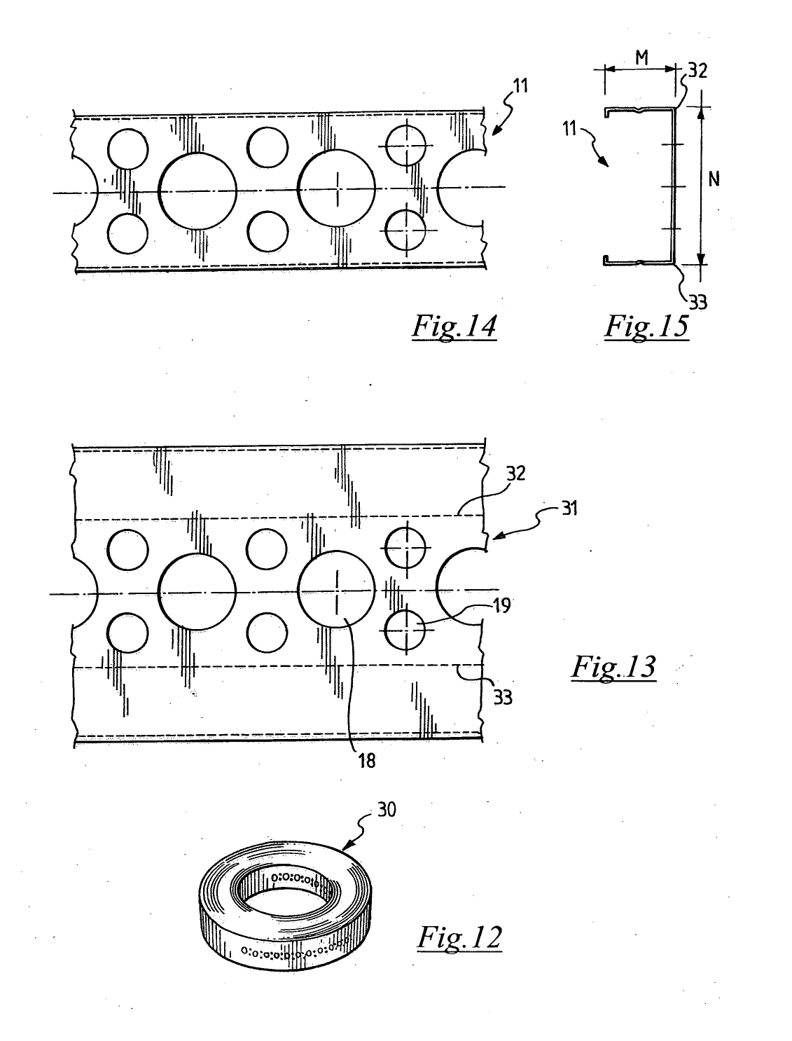

In particular, FIGS. 14 and 15 show a beam element 11 obtained with the aforementioned method, respectively in a front view and in a transversal section view. The profile of the beam element 11 is C-shaped and it is obtained by bending the side portions of the strip 31 by 90° with respect to the relative bending line 32, 33.

Preferably, the height N of the beam element 11, and consequently of the other beam elements 12-14, 111, 121 and 130-140, is of between 6 and 14 cm. The extension M of the lower and upper surfaces (horizontal portions of the C-shaped profile) is of between 3 and 6 cm.

The beam elements 11-14, 111, 121 and 130-140, cut according to the respective lengths foreseen by the design, are coupled as previously described, for example, through welding, bolts, rivets, etc . . . to form the framework of the formwork structure 1 and 1′ to which the reinforcement metal bars 17 or 170, the closing elements 16 or 160, etc., are added.

Also the shaped elements 15 are preferably obtained by cutting a strip 31 and bending it along specific bending lines.

1. Prefabricated stair formwork structure for making a flight of stairs, comprising:
a first space for containing a concrete cast defined by two first longitudinal beam elements, arranged parallel to one another, and two first transversal beam elements, also arranged parallel to one another and each coupled with both said first longitudinal beam elements at their respective ends,
a plurality of shaped elements each of which define a second containment space for a concrete cast of corresponding steps, said shaped elements being fixed in succession above said at least two first longitudinal beam elements,
an element for closing the bottom of the formwork structure, fixed to said first longitudinal beam elements and/or to said first transversal beam elements on the opposite side with respect to said shaped elements, and
a reinforcement structure of the concrete housed in said first containment space.

2. Prefabricated stair-landing formwork structure for making a stair-landing, comprising:
two first longitudinal beam elements, arranged parallel to one another, and two first transversal beam elements, also arranged parallel to one another and each coupled with both of said first longitudinal beam elements at the respective ends to define a containment space for a concrete cast,
an element for closing the bottom of the formwork structure, fixed to said first longitudinal beam elements and/or to said first transversal beam elements, and
a reinforcement structure for the concrete housed in said containment space.

3. Formwork structure according to claim 1 or claim 2, wherein each of said at least two first transversal beam elements is provided with a plurality of through holes.

4. Formwork structure according to claim 3, wherein said through holes of each of said at least two first beam elements are lined up with corresponding through holes of the other transversal beam element, and wherein said reinforcement structure comprises a plurality of reinforcement bars, which pass through some or all of said through holes and extend in said first containment space, parallel to said first longitudinal beam elements.

5. Formwork structure according to claim 4, wherein said at least two first longitudinal beam elements extend parallel to the direction of development of the flight of stairs or of the stair-landing and said at least two first transversal beam elements extend perpendicularly with respect to said longitudinal beam elements.

6. Formwork structure according to claim 4, comprising one or more second transversal beam elements arranged in said first containment space, parallel to said at least two first transversal beam elements, coupled with said at least two first longitudinal beam elements at an intermediate portion thereof, wherein said second transversal beam elements are provided with through holes aligned with corresponding through holes of said at least two first transversal beam elements and wherein said reinforcement structure comprises metal bars that pass through said first and said second transversal beam elements at their relative through holes.

7. Formwork structure according to claim 1 or claim 2, further comprising one or more second longitudinal beam elements arranged in said containment space, parallel to said at least two first longitudinal beam elements, coupled with said transversal beam elements at an intermediate portion thereof.

8. Formwork structure according to claim 1 or claim 2, wherein said longitudinal beam elements are provided with aligned through holes and wherein said reinforcement structure comprises a plurality of reinforcement bars which pass through said through holes and extend in said containment space, parallel to said transversal beam elements.

9. Formwork structure according to claim 1 or claim 2, wherein said longitudinal and transversal beam elements are substantially C-shaped slab elements.

10. Formwork structure according to claim 1, wherein said shaped elements are each provided with a riser portion of the corresponding step, and with two side portions adjacent to said riser portion, wherein the upper edge of said riser portion and the upper edge of said side portions define a support surface for coating elements of the corresponding step.

11. Formwork structure according to claim 10, wherein the two side portions are provided with aligned through holes through which, one or more reinforcement bars, are inserted parallel to said riser portion.

12. Formwork structure according to claim 1 or claim 2, wherein said longitudinal beam elements, said transversal beam elements and said shaped elements are made from a metal plate.

13. Formwork structure according to claim 1 or claim 2, wherein said element for closing comprises one or more panels.

14. Formwork structure according to claim 13, wherein said panels are made from magnesite.

15. Formwork structure according to claim 1 or claim 2, wherein said first transversal beam elements and/or said first longitudinal beam elements are provided with seats for engaging with elements for fixing onto external building structures or onto other formwork structures or they are provided with said fixing elements.

16. Formwork structure according to claim 3 when depending on claim 2, further comprising two or more stringers fixed beneath said longitudinal beam elements and/or said transversal beam elements to horizontally support said formwork structure at a set height with respect to a floor.

17. Method for making a formwork structure according to claim 1 or claim 2, comprising the steps of:
a) providing a strip made out of metal plate,
b) providing at least four beam elements, each having a predetermined length, bending the strip at at least two bending lines which are longitudinal with respect to the development of the strip itself and cutting the strip,
c) coupling said four beam elements, parallel two by two,
d) forming at least one containment space for a concrete cast between said at least four beam elements coupled by fixing one or more elements for closing beneath two or more of said beam elements,
e) providing the reinforcement structure for the concrete in said at least one containment space.

18. Method according to claim 17, wherein said reinforcement structure comprises a plurality of reinforcement bars, and wherein on at least two parallel beam elements there is a plurality of aligned through holes, and wherein providing the reinforcement structure for the concrete in the containment space comprises arranging said reinforcement bars in said containment space and through some or all of said aligned through holes.

19. Method according to claim 17, wherein on each beam element there are through holes which are lined up with the holes of the parallel beam element and wherein providing the reinforcement structure for the concrete in the containment space comprises arranging some reinforcement bars parallel to two beam elements and other reinforcement bars parallel to the remaining two beam elements, the reinforcement bars crossing each other in said containment space.

20. Method according to claim 17, wherein said strip is initially wound up in a reel and wherein providing the strip made of metal plate comprises the step of unreeling and straightening said strip.

21. Method according to claim 17, wherein said strip is made of galvanized metal plate.

22. Method according to claim 17, wherein the strip is bent by around 90° along said bending lines during providing said at least four beam elements and wherein the section of the resulting beam element is substantially C-shaped.

23. Method according claim 17, further comprising providing further beam elements and coupling the same with said four beam elements, parallel to two of them.

24. Method according to claim 17, further comprising:
f) fixing a plurality of shaped elements onto at least two beam elements at an upper portion thereof, each of said beam elements defining a space for the concrete cast of corresponding steps, arranged parallel to the remaining two beam elements.

25. Method for constructing a flight of stairs in a building comprising:
a) providing a formwork structure according to claim 1,
b) fixing one of said two first transversal beam elements to a structure of the building, foreseen at a first height, and fixing the other first transversal beam element, to a structure of the building, foreseen at a second height, which is greater compared to the first height,
c) fixing said closing element beneath said first longitudinal beam elements and/or to said first transversal beam elements, on the opposite side with respect to said shaped elements,
d) providing a reinforcement structure (C) for a concrete cast in said containment space, and
e) filling the first containment space, defined by said first transversal and longitudinal beam elements and by said closing element, with a concrete cast.

26. Method according to claim 25, wherein said reinforcement structure comprises a plurality of reinforcement bars and wherein providing the reinforcement structure for the concrete cast in the containment space comprises arranging said reinforcement bars in the containment space, with each bar extending through corresponding aligned holes of said first, longitudinal beam elements, parallel to said first transversal beam elements.

27. Method according to claim 25 or claim 26, further comprising closing the vacant holes of said first transversal beam elements with closing elements before the concrete is cast.

28. Method according to claim 25, further comprising filling the second containment space, defined by each of said shaped elements with a concrete cast and the step of closing the top of said shaped elements with slabs of covering material.

29. Method according to claim 25, wherein the structure of the building is a wall or a stair-landing and said reinforcement bars project out from said wall or said stair-landing or they are anchored to said wall or to said stair-landing.

30. Method for building a stair-landing in a building comprising the steps of:
a) providing a formwork structure according to claim 2,
b) horizontally fixedly attaching said formwork structure to a structure of the building, at one or more first beam elements,
c) fixing said closing element beneath said first longitudinal beam elements and/or to said first transversal beam elements,
d) arranging a reinforcement structure in said containment space, and
e) filling the containment space, defined by said first transversal and longitudinal beam elements and by said closing element, with a concrete cast.

31. Method according to claim 30, wherein said reinforcement structure comprises a plurality of reinforcement bars and wherein arranging the reinforcement structure comprises arranging the reinforcement bars in said containment space, parallel to said longitudinal beam elements and through said aligned through holes of the transversal beam elements.

32. Method according to claim 31, further comprising arranging a formwork structure according to claim 8, and wherein arranging the reinforcement structure comprises arranging a plurality of reinforcement bars in the containment space, with each bar extending through corresponding aligned holes of said first longitudinal beam elements, parallel to said first transversal beam elements.

33. Method according to claim 30, further comprising closing the vacant through holes of said first beam elements with closing elements before the concrete is cast.

34. Staircase of a building comprising a formwork structure claim 1.

35. Stair-landing of a building comprising a formwork structure according to claim 2.
